(19) United States
(12) Patent Application Publication
(10) Pub. No.: US 2006/0294358 A1
(43) Pub. Date: Dec. 28, 2006

(54) Methods and computers for presenting a graphical user interface during a boot process

(75) Inventor: Keng Chun Wang, Taipei County (TW)

Correspondence Address: QUINTERO LAW OFFICE, 1617 BROADWAY, 3RD FLOOR, SANTA MONICA, CA, 90404, US

(73) Assignee: LITE-ON TECHNOLOGY CORPORATION, TAIPEI (TW)

(21) Appl. No.: 11/436,430

(22) Filed: May 18, 2006

(30) Foreign Application Priority Data
Jun. 27, 2005 (TW) TW94121416

(51) Int. Cl. G06F 9/00

(52) U.S. Cl. 713/2

(57) ABSTRACT

A method for presenting a graphical user interface during a boot operation is implemented in a computer. The computer comprises a display, an input device, and an operating system (OS) comprising a loader and a kernel. The kernel comprises a menu provider and an initialization module for the input device. First, during the computer bootup, the loader loads the kernel. The menu provider shows a main menu on the display. The initialization module initializes the input device, enabling one option on the main menu to be selected through the input device. While the menu provider displays the main menu, the kernel continues initializing the computer.

### BACKGROUND

The invention relates to computer techniques, and in particular, to methods and computers for presenting a graphical user interface during a boot process.

Current personal computers or embedded systems, running the Windows or Linux operating system (OS), only display a graphical user interface (GUI) after completion of a lengthy boot process. FIG. 1 is a flowchart of a conventional boot procedure.

First, a computer is powered on (step S2), executes Basic Input/Output System (BIOS) and a boot loader (steps S4 and S6), and initiates a kernel of an OS according to the boot loader (step S8). The kernel subsequently initializes components and drivers of the computer (step S10). The computer executes OS initialization scripts (step S12), displays a GUI, and executes applications (step S14).

Thus, applications are not available until execution of the scripts is complete (step S12).

### SUMMARY

Accordingly, methods and computers for presenting a graphical user interface during a boot process are provided.

A first embodiment of a method for presenting a graphical user interface during a boot process is implemented in a computer comprising a display, an input device, a loader and a kernel of an operating system (OS). The loader loads the kernel at computer bootup. The kernel comprises a menu provider and an initialization module for the input device. The menu provider presents a main menu comprising a plurality of options. The initialization module initializes the input device, enabling one option to be selected through the input device. The kernel proceeds with other initialization operations of the computer while the menu provider presents the main menu.

A first embodiment of a computer comprises a display, an input device, a kernel of an operating system (OS), and a loader. The kernel comprises a menu provider and an initialization module for the input device. The loader loads the kernel at computer bootup. The menu provider presents a main menu comprising a plurality of options. The initialization module initializes the input device, enabling one option to be selected through the input device. The kernel proceeds with other initialization operations of the computer while the menu provider presents the main menu.

A second embodiment of a method for presenting a graphical user interface during a boot process is implemented in a computer comprising a display, an input device, and a loader and a kernel of an operating system (OS). The loader comprises a menu provider, an initialization module for the input device, and a parameter relay. The menu provider displays a main menu comprising a plurality of options on the display at computer bootup. The initialization module initializes the input device, enabling one option to be selected through the input device. The parameter relay receives and stores the option from the input device. The loader loads the kernel. An application corresponding to the option is automatically initiated after the computer boot is complete.

An exemplary embodiment of a method for presenting a graphical user interface during a boot process is implemented in a computer comprising a plurality of applications, a display, an input device, and a loader and a kernel of a Linux operating system (OS). The loader loads the kernel at computer bootup. The kernel comprises a menu provider and an initialization module for the input device. The loader loads the kernel at computer bootup. The menu provider presents a main menu comprising a plurality of options. The initialization module initializes the input device, enabling one option to be selected through the input device. The kernel proceeds with other initialization operations of the computer while the menu provider presents the main menu. Designation of a first option corresponding to a first application is received from the input device. The first application corresponding to the first option is automatically initiated after the computer boot is complete.

### DESCRIPTION OF THE DRAWINGS

The invention can be more fully understood by reading the subsequent detailed description and examples with references made to the accompanying drawings, wherein:

FIG. 1 is a flowchart of a conventional computer boot procedure;

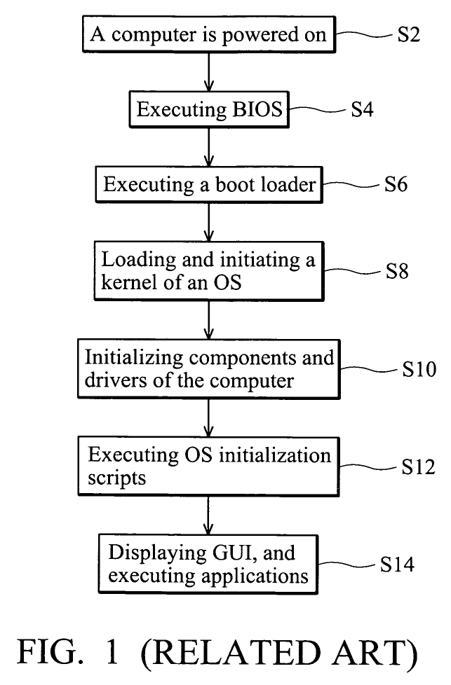

FIG. 2 is a block diagram of a first embodiment of an embedded system;

FIG. 3 is a flowchart of a first embodiment of a method for presenting a GUI during a boot process;

FIG. 4 is a schematic diagram of a main menu, applications, and the relationship thereof;

FIG. 5 is a block diagram of a second embodiment of a embedded system; and

FIG. 6 is a flowchart of a second embodiment of a method for presenting a GUI during a boot process.

### DETAILED DESCRIPTION

Methods and systems for presenting a graphical user interface during a boot process are provided. These methods can be implemented in embedded systems or other computers. For example, embedded systems comprise Personal Digital Assistant (PDA), mobile phones, printers, multifunction devices, network switches, routers, and firewalls.

### First Embodiment

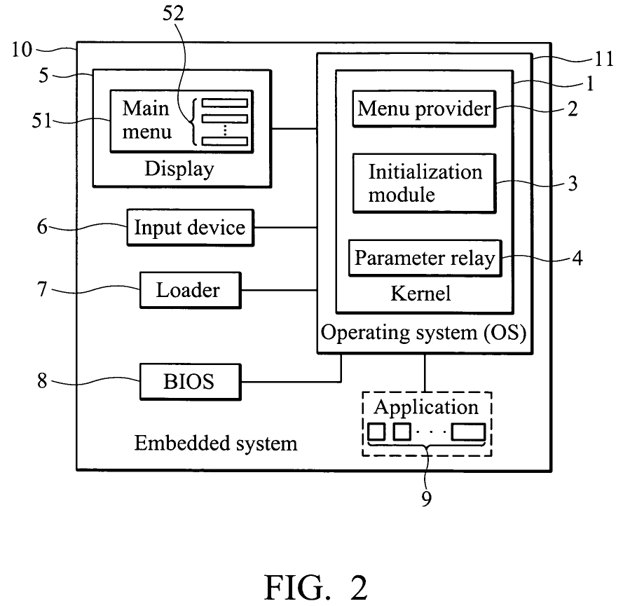

Embedded system 10 in FIG. 2 comprises display 5, input device 6, Basic Input/Output System (BIOS) 8, loader 7 and kernel 1 of operating system (OS) 11. Kernel 1 comprises menu provider 2, initialization module 3 for the input device 6, and parameter relay 4. For example, operating system 11 may be a Linux operating system. Input device 6 may comprise a keyboard, a computer mouse, a touch panel, or a wireless receiver which receives signal input from an external electronic device, such as a remote control.

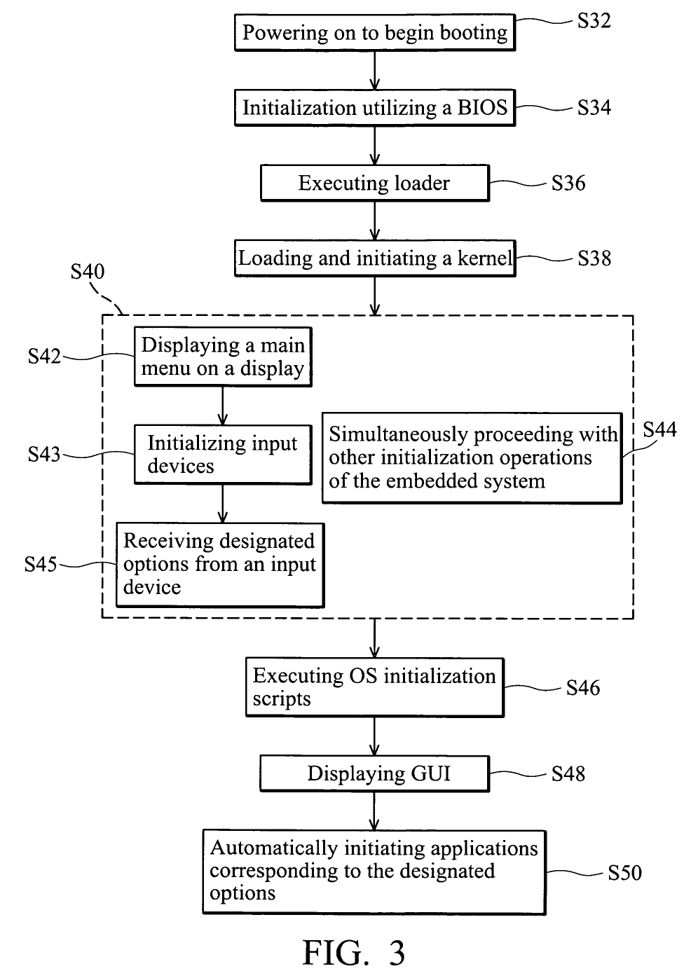

With reference to FIG. 3, embedded system 10 is powered on and begins booting (step S32). Embedded system 10 begins initialization utilizing BIOS 8 (step S34). Note that some embedded systems have no BIOS, thus this step is skipped.

After the initialization with BIOS 8 completes, loader 7 begins execution (step S36). Loader 7 loads and initiates kernel 1 (step S38). Kernel 1 performs initialization of embedded system 10 by multiprocessing (step S40), comprising the following steps: menu provider 2 displays main menu 51 on the display 5 (step S42); initialization module 3 initializes input device 6, enabling options 52 on the main menu 51 to be selected through input device 6 (step S43); kernel 1 proceeds with other initialization operations of embedded system 10 while menu provider 2 displays main menu 51 (step S44); and parameter relay 4 receives designation to options 52 from input device 6 (step S45).

In step S42, menu provider 2 can configure the layout of main menu 51 the background of which may be a still or animated image.

In step S43, initialization module 3 may assign instructions or an option 52 corresponding to each component of input device 6. For example, input device 6 comprises a plurality of keys, each of which corresponds to an option 52. Furthermore, each option 52 of main menu 51 corresponds to an application 9. When a key is depressed corresponding to an option 52, a corresponding application 9 is executed. GUI components (such as a cursor or checkboxes) of menu 51 may reflect the operation of input device 6. Additionally, simultaneous execution of the previously described steps may be implemented by multi-thread or multi-process techniques.

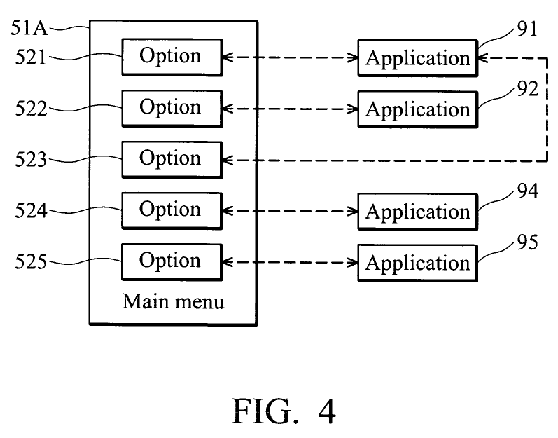

Main menu 51A in FIG. 4 is an example of main menu 51. A cursor can be controlled by input device 6 to select options 521˜525 which correspond to applications 91, 92, 91, 94, and 95 respectively. Applications 91, 92, 94, and 95 are respectively a TV program recorder, a music player, an Internet phone program, and an image viewer. Options 521, 522, 523, 524, and 525 can be designated to initiate playback of the TV program recorder, the music player, recording function of the TV program recorder, the Internet phone program, and the image viewer respectively.

Initialization operations in step 44 comprise initializing other devices, drivers thereof, virtual disks, a file system, and a root directory.

Note that steps S42 and S44 can be performed simultaneously, as steps S43 and S44. Steps S42 and S43 can be performed simultaneously or sequentially.

Embedded system 10 subsequently executes OS initialization scripts (step S46) and displays GUI (step S48). According to the designation, embedded system 10 automatically initiates application 9 corresponding to the designated option 52 after bootup is complete (step S50). The designation comprises a function parameter of the corresponding application 9. The corresponding application 9 executes the function in response to the designation. When more options 52 are designated, corresponding applications thereof can be executed simultaneously utilizing multiprocessing.

For example, parameter relay 4 temporarily stores the designation in an area (such as a predetermined directory under /proc directory in the Linux OS) of a memory of embedded system 10. When executed, OS initialization scripts retrieve the designation and initiate an application. Parameter relay 4 may initiate an application 9 to which the designated option 52 corresponds according to the designation. Alternatively, an initiated corresponding application 9 retrieves the designation and performs corresponding functions accordingly.

In step S36, loader 7 may display the background of main menu 51.

A computer with a 2 GHz central processing unit (CPU) and a Linux OS requires 68˜70 seconds to show an application GUI. Another computer implementing the method under the same condition only requires 10˜12 seconds to show a GUI, such as main menu 51. With no BIOS, an embedded system with a Linux kernel only supporting a limited number of devices requires 4˜9 seconds to show an application GUI. An embedded system implementing the method under the same condition only requires 3˜4 seconds to show a GUI, such as main menu 51.

### Second Embodiment

The second embodiment may be considered the same as the first embodiment except for that which is described in the following.

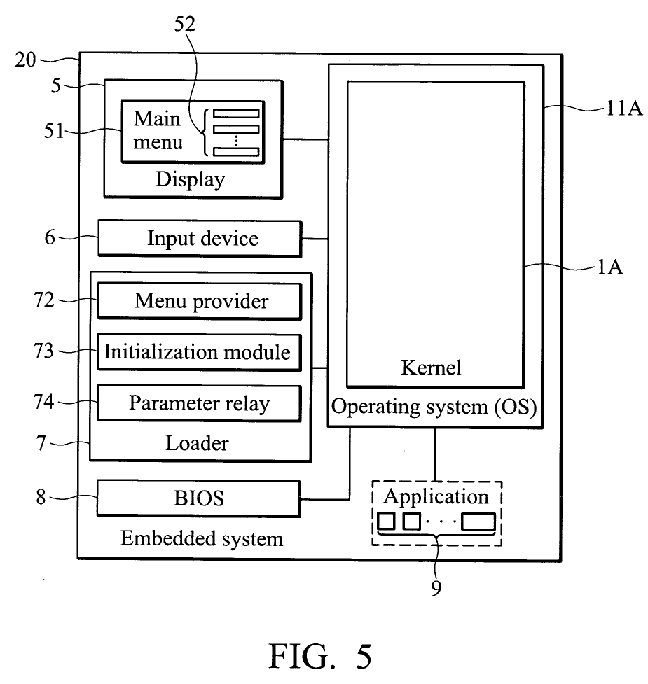

With reference to FIG. 5, loader 7 comprises menu provider 72, initialization module 73, and parameter relay 74.

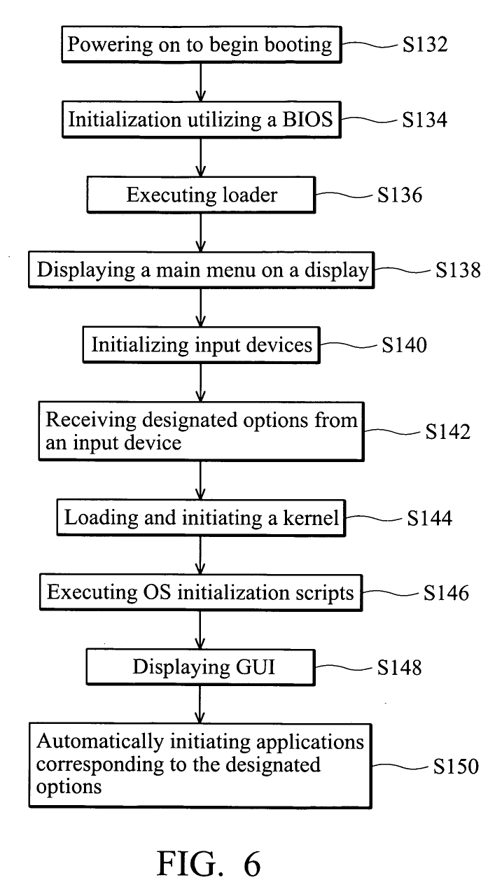

With reference to FIG. 6, embedded system 20 is powered on and begins booting (step S132). Embedded system 20 begins initialization utilizing BIOS 8 (step S134). After the initialization with BIOS 8 is complete, loader 7 begins execution (step S136). Menu provider 72 displays main menu 51 on the display 5 (step S138).

Initialization module 73 initializes input device 6, enabling options 52 on the main menu 51 to be selected through input device 6 (step S140). Parameter relay 74 receives designation to option 52 from input device 6 (step S142).

Loader 7 subsequently loads and initiates kernel 1A (step S144). Embedded system 20 executes OS initialization scripts (step S146) and displays GUI (step S148). Embedded system 20 automatically initiates application 9 corresponding to the designated option 52 according to the designation after bootup is complete (step S150).

Thus, according to the second embodiment, main menu 51 can be shown earlier than in the first embodiment in booting embedded system 20. In conclusion, a computer implementing the methods can provide interfaces for dynamically designating applications before bootup is complete and subsequently execute the designated applications.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for presenting a graphical user interface during a boot process, implemented in a computer comprising a display, an input device, and a loader and a kernel of an operating system (OS), comprising:
loading of the kernel by the loader during the boot process, wherein the kernel comprises a menu provider and an initialization module for the input device;
displaying a main menu comprising a plurality of options on the display by the menu provider;
initialization of the input device by the initialization module, enabling one option to be selected through the input device; and
proceeding of other initialization operations of the computer by the kernel while the menu provider displays the main menu.

2. The method as claimed in claim 1, wherein the kernel further comprises a parameter relay receiving and storing designation to the option from the input device, and automatically initiating an application to which the option corresponds according to the designation after the boot process completes.

3. The method as claimed in claim 2, wherein the designation comprises a function parameter of the application, and the application executes the function in response to the designation.

4. The method as claimed in claim 2, wherein the operating system is a Linux operating system.

5. The method as claimed in claim 2, wherein the input device comprises a keyboard, a computer mouse, a touch panel, or a wireless receiver.

6. The method as claimed in claim 2, wherein the loader displays the background of the main menu.

7. A computer, comprising:
a display;
an input device;
a kernel of an operating system (OS), comprising a menu provider and an initialization module for the input device; and
a loader loading the kernel during a boot process, wherein the menu provider displays a main menu comprising a plurality of options on the display, the initialization module initializes the input device, enabling one option to be selected through the input device, and the kernel proceeds with other initialization operations of the computer while the menu provider displays the main menu.

8. The computer as claimed in claim 7, wherein the kernel further comprises a parameter relay receiving and storing designation to the option from the input device, and automatically initiating an application to which the option corresponds according to the designation after the boot process is complete.

9. The computer as claimed in claim 8, wherein the designation comprises a function parameter of the application, and the application executes the function in response to the designation.

10. The computer as claimed in claim 7, wherein the operating system is a Linux operating system.

11. The computer as claimed in claim 7, wherein the input device comprises a keyboard, a computer mouse, a touch panel, or a wireless receiver.

12. The computer as claimed in claim 7, wherein the loader displays the background of the main menu.

13. A method for presenting a graphical user interface during a boot process, implemented in a computer comprising a display, an input device, and a loader and a kernel of an operating system (OS), wherein the loader comprises a menu provider, an initialization module for the input device and a parameter relay, comprising:
displaying a main menu comprising a plurality of options on the display by the menu provider during the boot process;
initializing of the input device by the initialization module, enabling one option to be selected through the input device;
receiving and storing a designated option by the parameter relay from the input device;
loading of the kernel by the loader; and
automatically initiating an application corresponding to the designated option after the computer boot process is complete.

14. The method as claimed in claim 13, wherein the designated option comprises a function parameter of the application, and the application executes the function in response to the function parameter.

15. The method as claimed in claim 13, wherein the operating system is a Linux operating system.

16. The method as claimed in claim 13, wherein the input device comprises a keyboard, a computer mouse, a touch panel, or a wireless receiver.

17. A method for presenting a graphical user interface during a boot process, implemented in a computer comprising applications, a display, an input device, and a loader, and a kernel of an operating system (OS), comprising:
loading of the kernel by the loader during the boot process, wherein the kernel comprises a menu provider and an initialization module for the input device;
displaying of a main menu comprising a plurality of options on the display by the menu provider;
initialization of the input device by the initialization module, enabling the options to be selected through the input device, wherein the options correspond to the applications;
proceeding of other initialization operations of the computer by the kernel during the menu provider displays the main menu;
reception of designation of a first option corresponding to a first application from the input device; and
automatically initiating the first application according to the first option after the boot process is complete.
